(19) United States
(12) Patent Application Publication
(10) Pub. No.: US 2025/0114825 A1
(43) Pub. Date: Apr. 10, 2025

(54) FLAT SURFACE CLEANING MACHINE WITH AERODYNAMICALLY SHAPED SPRAY BAR ASSEMBLY

(71) Applicants: Matthew C. Baldwin, Morris, OK (US); Maxwell C. Baldwin, Morris, OK (US)

(72) Inventors: Matthew C. Baldwin, Morris, OK (US); Maxwell C. Baldwin, Morris, OK (US)

(21) Appl. No.: 18/904,469

(22) Filed: Oct. 2, 2024

Related U.S. Application Data
(60) Provisional application No. 63/542,977, filed on Oct. 6, 2023.

(51) Int. Cl. B08B 3/02

(52) U.S. Cl. CPC B08B 3/024

(57) ABSTRACT

Apparatus for cleaning a horizontally extending floor surface. In some embodiments, a flat surface cleaning machine has an inverted cup-shaped deck and a swivel coupled to a source of pressurized liquid such as water. A rotatable spray bar assembly extends from the swivel and includes an elongated hub member, an arm member threadingly coupled to the hub member, and a nozzle threadingly coupled to the arm member. Shoulder limit surfaces set the rotational position of the arm member relative to the hub member to position the nozzle at a desired operational angle such as from 5-30 degrees. Interior channels along the hub and arm members are shaped to efficiently convey the pressurized fluid to the nozzle. Multiple hub and arm members may form a T, X, Y or star-shaped pattern. The spray bar has an aerodynamically shaped outer surface profile to reduce weight, vibration and turbulence during operation.

### RELATED APPLICATIONS

The present application makes a claim of domestic priority to U.S. Provisional Patent Application No. 63/542,977 filed Oct. 6, 2023, the contents of which are hereby incorporated by reference.

### BACKGROUND

Flat surface cleaning machines can be used to clean an underlying surface in a controlled fashion using pressurized water or other liquids. Such machines often include a downwardly facing housing or base deck which encloses a spray bar assembly coupled to a swivel. Pressurized liquid passes from a source and through the swivel to the bar, which distributes the liquid through one or more interior channels to an array of discharge nozzles.

The nozzles may be arranged to induce rotational thrust to the bar, thereby causing the bar to rotate at a high rate of speed as the pressurized liquid impinges the underlying floor surface. A user handle assembly can be used to allow an operator to manually advance the machine across the floor and spray wash a large area. The base deck largely shields the surrounding environment from the fluid, overspray, debris, etc. that are generated by the localized action of the pressurized spray upon the underlying surface. The floor washing action results in the generation of contaminant retaining fluid on the surface which can be mopped up, directed to a drain, vacuumed up, or simply allowed to dry.

Flat surface cleaning machines can be used to efficiently clean any number of water impermeable floor surfaces such as but not limited to concrete, asphalt, tile, etc. The machines are suitable for both internal applications such as businesses, processing plants, warehouses, aircraft hangers, etc. and external applications such as parking lots, drive ways, tarmacs, tennis courts, etc.

While a variety of flat surface cleaning machines have been introduced, there remains a continual need for improvements in the art to enhance durability, operational efficiency and effectiveness of a flat cleaning surface operation. It is to these and other improvements that various embodiments of the present disclosure are generally directed.

### SUMMARY

Various embodiments are generally directed to systems and methods for cleaning a horizontally extending floor surface.

In some embodiments, a flat surface cleaning machine has an inverted cup-shaped deck and a swivel coupled to a source of pressurized liquid such as water. A rotatable spray bar assembly extends from the swivel and includes an elongated hub member, an arm member threadingly coupled to the hub member, and a nozzle threadingly coupled to the arm member. Shoulder limit surfaces set the rotational position of the arm member relative to the hub member to position the nozzle at a desired operational angle such as from 5-30 degrees. At least a selected one of the hub member or the arm member has an aerodynamically shaped outer surface profile to enhance rotational performance of the spray bar assembly. Interior channels extending through the spray bar assembly may undergo a reduction in size along the hub and arm members to control the application of the pressurized fluid to the nozzle. The hub and arm members may form a T, X, Y or star-shaped pattern.

These and other features and advantages of various embodiments can be understood with a review of the following detailed description in conjunction with a review of the accompanying drawings.

### BRIEF DESCRIPTION OF DRAWINGS

FIG. 1 is a functional block diagram of a floor cleaning system constructed and operated in accordance with some embodiments.

FIG. 2 is an elevational cross-sectional representation of another floor cleaning system similar to that shown in FIG. 1.

FIG. 3 is a side elevational representation of a spray bar assembly of FIGS. 1-2 in some embodiments, the spray bar assembly having a two-way configuration.

FIG. 4 is an isometric representation of the spray bar assembly of FIG. 3 in some embodiments.

FIGS. 5A through 5C show different cross-sectional configurations of a central hub member of the assembly of FIGS. 3-4 in accordance with different embodiments.

FIG. 6 is a cross-sectional representation of a junction coupling established between a selected end of the central hub member and one of the opposing arms depicted in FIGS. 2-4.

FIG. 7 provides an arrangement of different configurations of arm members that can be affixed to the central hub member in accordance with various embodiments.

FIG. 8 shows another arm member with multiple spaced apart nozzles in accordance with further embodiments.

FIG. 9 shows a multi-head nozzle assembly that attaches to an associated arm member and provide multiple nozzle outlets at different relative angles.

FIG. 10 is a schematic representation of relevant aspects of another flat surface cleaning machine in which multiple spray bar assemblies are utilized in tandem in accordance with further embodiments.

FIG. 11 shows yet another spray bar assembly in accordance with further embodiments in which a four-way configuration is provided.

FIG. 12 is an isometric depiction of another arm member constructed and operated in accordance with further embodiments.

FIG. 13 is an isometric depiction of a nozzle member suitable for mating engagement with the arm member of FIG. 12.

FIG. 14 shows an assembled spray arm assembly using the elements of FIGS. 12-13 in further embodiments.

FIG. 15 is another isometric depiction of the arm member of FIG. 12 in some embodiments.

FIG. 16 is another view of the assembled spray arm assembly of FIG. 14 in further embodiments.

FIG. 17 shows a family of spray arm assemblies that can be formed using the arm member of FIGS. 12 and 15.

FIGS. 18A and 18B show front and rear isometric depictions of another arm member constructed and operated in accordance with further embodiments.

FIGS. 19A and 19B show respective top and bottom views of an assembled spray arm assembly that includes the arm member of FIGS. 18A-18B in further embodiments.

FIG. 20 is a top plan schematic representation of another spray arm assembly in accordance with further embodiments.

FIG. 21 is a cross-sectional elevational representation of a locking assembly of the spray arm assembly of FIG. 20 in some embodiments.

FIGS. 22A and 22B show additional configurations of spray arm assemblies in accordance with further embodiments.

FIG. 23 is a functional block representation of a manually operated flat surface cleaning machine in further embodiments.

FIGS. 24A and 24B show functional block representations of autonomous and user driven machines in accordance with further embodiments.

FIG. 25 is a sequence diagram to illustrate assembly and use of various embodiments of the present disclosure.

### DETAILED DISCUSSION

Without limitation, various embodiments of the present disclosure are generally directed to an improved spray bar assembly for a flat surface cleaning machine of the type that an operator can use to controllably move over a flat surface to apply a flow of high pressure water or other fluid during a floor cleaning operation.

Operational environments in which the flat surface cleaning machine can be used include, but are not limited, to, warehouses, hangers, industrial and retail business facilities, driveways, parking lots, sidewalks, tarmacs, runways, tennis courts, or essentially any other substantially horizontally extending planar surface that can be cleaned with water or other liquids.

As explained below, at least some embodiments provide a rotatable spray bar which attaches to a central swivel to receive pressurized water at selected flow rates and pressures. Any number of suitable ranges can be used. One example is a flow rate on the order of around 5-12 gallons per minute and pressures on the order of around 500-3000 pounds per square inch (psi). Other values can be used so these are merely for illustration and are not limiting. Depending on the configuration of the system, the bar may rotate at a rotational rate of several hundred revolutions per minute (RPM), such as 200-1000 rpm or more, etc.

The spray bar rotates about a central axis nominally aligned with the central swivel as a result of the introduction, passage and emission of the pressurized water. To this end, an interior hub channel extends along an interior of the spray bar along a longitudinal axis that is aligned along an overall length of the hub member. The interior hub channel directs the water from a centrally located inlet port to the distal ends of the bar for emission via respective nozzles that attach adjacent the ends of the bar.

Any number of different swivel and nozzle configurations can be used as desired, including but not limited to existing, commercially available items. The nozzle apertures and nozzles may be set at selected offset angles with respect to a longitudinal axis of the bar in order to induce rotation of the bar about the central axis in a desired rotational direction.

Some embodiments provide a two-way (T-shaped) spray bar configured to be a three-piece unit with a central hub member and end (arm) members which are removably attachable to the respective ends of the central hub member. The central hub member is provided with an outer surface that is aerodynamically shaped to reduce weight/inertia/mass as well as to enhance aerodynamic efficiency as the spray bar rotates.

While not necessarily required, the spray bar may be provided with an aerodynamically shaped outer surface profile. In some embodiments, the central hub member has a substantially D-shaped cross section with a circumferentially extending cylindrical outer surface that is discontinuously transitioned to a flat (chordal) outer surface. In this way, the central hub member is symmetric and balanced about the central rotational axis. Other cross-sectional shapes can be utilized for the central hub member, including non-symmetric arrangements that are asymmetric about the central axis such as hub members that generally take the shape of an airplane wing (airfoil), a tear drop, etc.

In further embodiments, the arm member can be provided with an aerodynamically shaped outer surface profile such as through the use of an H-shaped profile formed from two larger housing ends and a narrowed intermediate portion with a reduced circumference area. The aerodynamically shaped profile of the hub member(s) and/or the arm member(s) provides a number of benefits including reduced weight of the spray arm assembly and reduced turbulence within the spraying area, thereby providing faster rotation, higher effective pressure sprays, and better controlled application of the pressurized liquid against the underlying surface.

A localized flat surface can be provided on a top surface of the central member to accommodate securement of threaded hardware from the swivel that engages a threaded aperture that extends into the body of the central hub member.

The two arm members disposed at each end of the central hub member are nominally identical and include an interior arm channel that aligns with the central interior hub channel of the central hub. In some cases, a size restriction is used so that the hub has a first, larger interior diameter and the arms have a second, smaller interior diameter. While not limiting, some embodiments provide a first interior diameter of nominally 0.5 or ½ inches, which stepwise or gradually transitions to a second interior diameter of nominally 0.375 or ⅜ inches. Other relative and absolute dimensions can be used.

The arms threadingly engage the ends of the central hub to align therewith. A limit feature, such as a shoulder surface adjacent the threaded portion of the hub, mates with a corresponding limit feature of the associated arm. In this way, a watertight seal is established at each arm-hub junction and the arms are set at a precise rotational position. As desired, optional sealing members such as a layer of Teflon tape, an elastomeric seal/compound, etc. can be introduced to further establish a fluidic seal at the junctions between the respective arms and hub. Alignment features can be provided to establish a visual indication to the user that the arm has been properly advanced to the correct position.

It is contemplated that the hub and the arms will each be formed of one or more lightweight, rigid and durable materials. The hub and arms may be formed of the same material, or may be formed of different materials. In some embodiments, the hub is aluminum and the arms are stainless steel. Other metals can be used. Non-metal durable materials can also be used including reinforced or non-reinforced injection molded plastic, nylon, PVC, thermoset resins, ceramics, etc.

The spray bar is configured to be mounted within a flat surface cleaning machine so that the rotatable bar extends within a deck that retains the spray and debris. The deck can include brushes, wheels and other members to enable a user, via a handle assembly, to controllably advance the rotating spray bar over a large area. While a single spray bar may be used, other embodiments contemplate an elongated system where multiple bars are arranged in tandem to cover a larger area.

While manually advanced machines are contemplated in which the user walks behind and physically moves the deck and spray bar across the floor surface, the various embodiments presented herein can readily be adapted for use in other configurations such as autonomous machines (e.g., robotic devices), machines with an electric or internal combustion engine (ICE) drivetrain to enable the user to drive the machine along a desired path, and so on.

The various sizes and aspect ratios of the rotating spray bar will depend on the requirements of a given application. Without limitation, some embodiments provide an overall length of the spray bar of around 17-21 inches and an overall diameter of nominally 1.5 inches. Other respective dimensions can be used.

The central hub may be on the order of about 10-12 inches in length, and the arms may be provided with different overall lengths (e.g., arms of 3 inches, 4 inches, 6 inches, etc.). This allows the same central hub to be provided and different replacement arms be installed as needed. In alternative embodiments, the sizes of the arms are standardized to a common size, and different lengths of central hubs are provided to accommodate different overall spray bar lengths.

Another advantage of various embodiments is that wear has been found to primarily occur at the arm positions, so having removably replaceable arms can allow a user to easily remove the existing arms and replace with new arms without the need to disassembly the unit further. This also allows different sprayer head configurations to be easily switched in and out for different cleaning applications. While not necessarily limiting, it is contemplated that the arms in a given spray bar will tend to have the same overall size, length and weight (mass) in order to maintain balance in the rotation of the bar.

While each of the arms is contemplated as having a single sprayer nozzle, other embodiments are contemplated, including multiple nozzles from a single aperture, multiple nozzles spaced along the length of the arm, and so on. When multiple nozzles are provided on the same arm, the nozzles may be arranged at different rotational angles with respect to the central hub.

While some embodiments generally take a two-arm configuration so that the spray arm assembly generally takes an overall T-shape, other embodiments provide other numbers of arms such as a four-arm configuration so that the spray arm assembly generally takes an overall X-shape. In this latter case, an X shaped central member can be coupled to the swivel, and four shaped hub members can extend outwardly from the central member at 90 degree intervals. The hub members can be provided with aerodynamic features and four cylindrical arms with associated nozzles can thereafter be attached to the ends of the hub members as described previously. Substantially any number of arms can be provided such as three-arms (e.g., a Y-configuration with the arms nominally 120 degrees apart), five-arms (e.g., a star-configuration with the arms nominally 72 degrees apart), and so on.

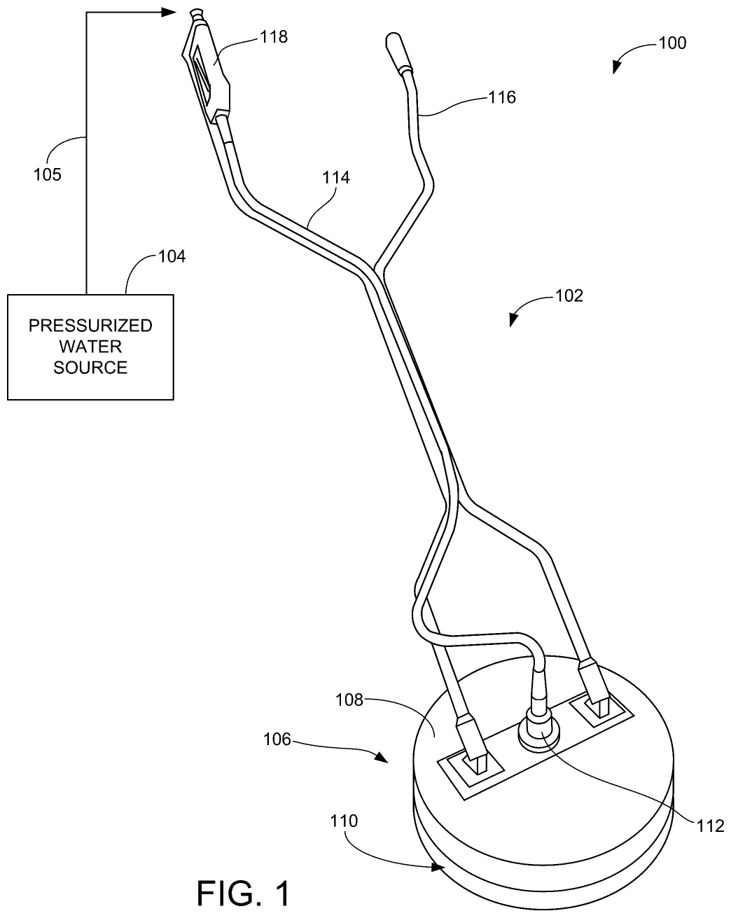

These and other features and advantages of various embodiments can be understood with a review of FIG. 1 which provides an isometric representation of a cleaning system 100 constructed and operated in accordance with various embodiments.

The cleaning system 100 is adapted for cleaning a substantially horizontally extending planar surface such as a floor using a pressurized liquid such as water. To this end, a flat surface cleaning machine (cleaner) 102 is shown coupled to an external pressurized water source 104 via a suitable conduit 105. In the present embodiment it is contemplated that ordinary ambient temperature water is used by the cleaner 102, and this water is supplied via a pump or other mechanism of the source 104.

The pump may be driven by an electric motor, an ICE, etc. The conduit 105 may be in the form of a flexible hose. Other options include heated water, water mixed with soaps, detergents or other additives, non-water based liquids, etc.

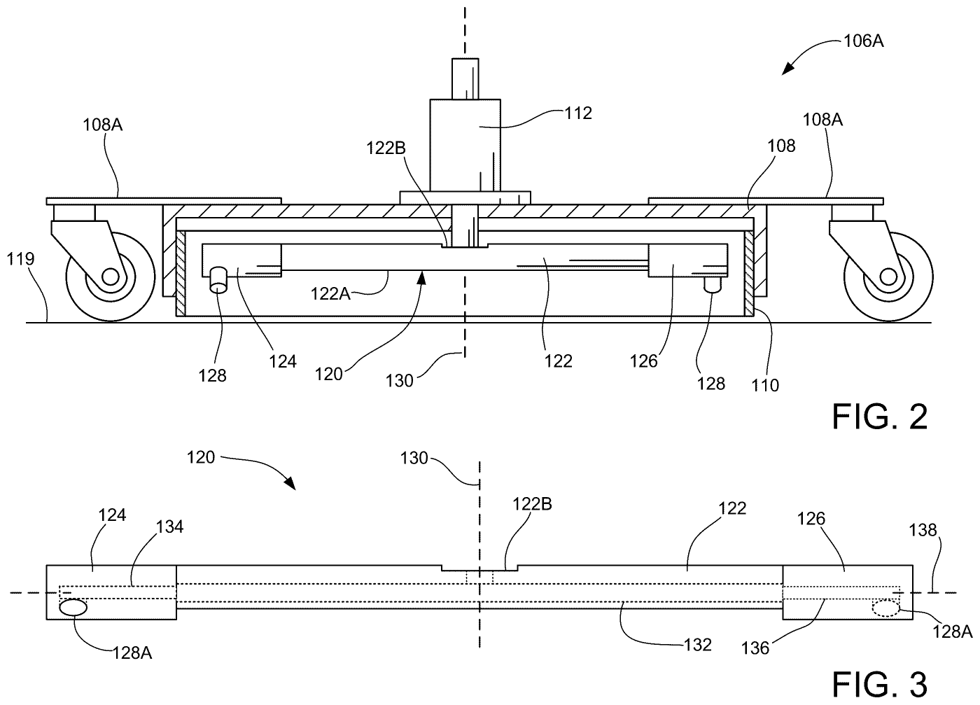

The cleaner 102 includes a base deck assembly 106 that rests upon an underlying floor surface (not separately denoted in FIG. 1). The base deck assembly 106 includes a deck housing (deck) 108 which takes an inverted cup-shape as shown more fully in FIG. 2. An array of brushes 110 can extend along an interior circumferentially extending surface of the deck 108 and project downwardly to extend close to or in contacting engagement with the floor to shield the operator and the surrounding environment from overspray, debris, etc.

A swivel assembly 112 is positioned in a central location of the deck housing 108 to provide fluidic delivery of the pressurized water from the source 104 via a conduit (flexible hose) 114. The conduit 114 is affixed to and aligned along a user handle 116 configured to enable a user to move and advance the base deck assembly 106 along the floor surface.

A user-activated wand trigger assembly 118 is incorporated into the handle 116 and allows the user to selectively flow the pressurized water to the base deck assembly 106. Other configurations can include one or more valves that can be selectively opened and closed to control the flow of the pressurized water to the unit.

FIG. 2 is a cross-sectional elevational representation of another base deck assembly 106A in accordance with further embodiments. The base deck assembly 106A is nominally identical to the base deck assembly 106 in FIG. 1, except that an array of castors 108A are affixed to the deck housing 108 to support the weight thereof and to maintain the deck housing 108 at a desired clearance relation to the underlying floor surface being cleaned (denoted at 119 in FIG. 2).

A spray bar assembly constructed and operated in accordance with some embodiments of the present disclosure is generally represented at 120. As explained below, the spray bar assembly 120, or spray bar, takes a two-arm (“two-way”), three-piece configuration and has a general T-shape. The spray bar 120 includes a central hub member 122 affixed to the spindle 112, and opposing first and second ends to which are attached respective first and second arm members 124, 126. Each of the arm members 124, 126 (arms) has at least one nozzle 128 extending from a distal end thereof. For reference, the central hub member 122 is also sometimes referred to as a “hub,” the arms 124, 126 are also sometimes referred to as “ends,” and the nozzles 128 are also sometimes referred to as “tips.”

With reference again to FIG. 1, during operation the pressurized water from the source 104 flows through the conduit 105, trigger assembly 118, conduit 114 and the spindle 112 for passage into and through the spray bar 120 (see FIG. 2) for distribution through the respective nozzles 128. During the application of the pressurized water, the thrust supplied by the pressurized water exiting the nozzles 128 induces rotation of the spray bar 120 about a central rotational axis 130.

The nozzles 128 can take any number of configurations depending on the requirements of a given application. Industry standard nozzle configurations include but are not limited to MEG, IMEG, PMEG, VJ, and others. Those skilled in the art will recognize that each of these and other types of industry standard nozzles provide different spraying characteristics and are suitable for different applications.

Regardless of size and shape, most nozzles tend to have a body formed of a hard and durable material such as tungsten carbide with a threaded base that can be threadingly inserted into a corresponding aperture, and a head that is contoured to provide a specific spraying pattern (e.g., jet, fan, oval, etc). While not limiting, at least some embodiments contemplate the use of IMEG configured nozzles with a ¼ inch male threaded connection and a 15 degree spray pattern. Other nozzles, including specially configured nozzles, can be used as desired.

The spindle 112 may also be obtained from a number of commercially available suppliers, or may be custom manufactured as desired. As will be recognized by the skilled artisan, the spindle includes an outer housing and an interior channel with an inlet (in this case, coupled to hose 114) and an outlet (in this case, coupled to the spray bar 120). One or more bearing and seal assemblies allow rotation of the outlet coupling while the inlet coupling remains in a stationary, non-rotating orientation. Internal sealing mechanisms (not separately shown) such as o-rings, gaskets, tape, liquid sealing compound, etc. can be used to ensure no leak paths are provided between the rotating and stationary elements.

FIG. 3 shows the spray bar 120 from FIG. 2 in greater detail. The central hub member 122 includes an aerodynamically shaped outer surface with a lower flat surface 122A that chordally extends across the otherwise cylindrically shaped surface to provide a substantially D-shaped cross section. Optionally, an upper flat surface 122B is additionally provided opposite and parallel to the lower flat surface 122A. The upper flat surface 122B enables efficient threading engagement of the spray bar 120 to a corresponding threaded coupling at the outlet of the spindle 112. This D-shaped cross-section provides the spray bar 120 with an aerodynamically shaped outer surface profile. Other profile configurations can be used.

An interior channel 132 extends along the length of the central hub member 122. This hub interior channel 132 is in fluidic communication with the spindle and directs the pressurized water in opposing directions therealong to corresponding arm interior channels 134, 136 in the respective arms 124, 126. While not limiting, in at least some embodiments the hub interior channel 132 is provided with a first internal diameter, such as but not limited to 0.5 (½) inches, and the arm interior channels 134, 136 are each provided with a second internal diameter, such as but not limited to 0.375 (⅜) inches. Other sizes can be used, including arm interior channels 134, 136 that are nominally the same size as (or even larger than) the hub interior channel 132.

The respective ends of the arm interior channels 134, 136 are fluidically coupled to threaded apertures 128A to accommodate the threaded nozzles 128 discussed above. While not limiting, it is contemplated that the respective interior channels 132, 134 and 136 are all axially aligned along a central longitudinal axis 138 of the spray arm 120. The reduction in size of the interior channels provides enhanced pressure at the nozzles 128.

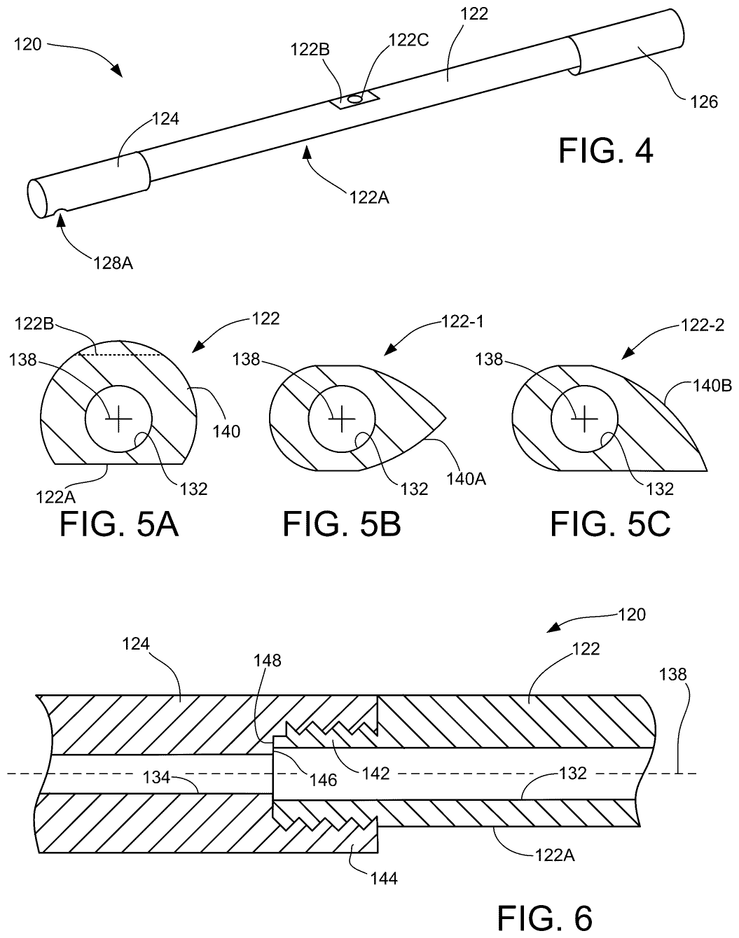

FIG. 4 is an isometric representation of the spray arm 120 of FIGS. 2-3 in some embodiments. The various features denoted in FIG. 3 are shown in FIG. 4. In addition, a threaded aperture 122C is shown to extend through the optional upper flat surface 122B for mating engagement with the lower coupling of the swivel 112. While not shown in detail, similar flat surfaces can be provided adjacent the nozzle apertures 128A to facilitate interconnection of the nozzles 128 with the respective arms 124, 126.

As noted previously, the central hub member 122 is aerodynamically shaped in order to have a lower cross section than the outer cylindrical shapes of the arms 124, 126. This provides a number of operational advantages including reduced weight and inertia, enhanced efficiency, and reduction of turbulence within the interior chamber defined by the deck housing 108 and the brushes 110 (see FIGS. 1-2). In some embodiments, the central hub member 122 is formed of aluminum and the arms 124, 126 are formed of stainless steel. Other arrangements can be used.

FIG. 5A shows the aforedescribed D-shaped configuration for the hub member 122. In this case, an outer surface 140 of the hub member 122 has a first portion that is curvilinearly extending (e.g., substantially cylindrically shaped with a constant radius from the longitudinal axis 138. The outer surface 140 is further discontinuous by the planar (flat) surface 122A which extends across the width of the spray bar 120.

While the flat surface 122A is shown to be nominally horizontal and thus, parallel to the underlying floor surface 119 (FIG. 2), other configurations contemplate angling the flat surface 122A so as to have a positive or negative rake (pitch) with respect to the direction of rotation. It will be recognized that such angling will result in the flat surface 122A extending along a plane that is no longer parallel to the upper flat surface 122B, so such design considerations should be established during manufacturing of the hub member 122.

For reference, the configuration of the cleaner 102 in FIGS. 1-4 is such that the spray arm 120 rotates in a clockwise direction about the central rotational angle 130 when looking down at the base deck assembly 106 (FIG. 1). Other arrangements can be used, however. Regardless, it will be noted that the configuration in FIG. 5A is symmetrical about a vertical plane that intersects the vertically extending rotational axis 130 (FIG. 3).

Because of the D-shape of the hub member 122 in FIG. 5A, the hub interior channel 132 is aligned with the longitudinal axis 138 but is offset with respect to the center of gravity of the member. This is not necessarily an issue, provided the material thickness is sufficient to retain the pressurized water (or other liquid). However, in other embodiments the hub interior channel 132 can be offset from the longitudinal axis 138 as desired; for example, the interior channel 132 in FIG. 5A can be relocated upwardly. While cylindrically shaped interior channels are contemplated, such are merely illustrative and are not limiting, as any suitable shapes, including elongated, rectilinear, etc. can be used.

FIG. 5B shows an alternative central hub member 122-1 that can be used in lieu of the central hub member 122 shown in FIGS. 2-4. The hub member 122-1 has an outer extending surface 140A that takes a generally tear-shaped configuration with upper and lower continuously extending curvilinear surfaces that taper along a trailing edge. In this case, the hub member 122-1 is substantially symmetrical about a horizontal plane that intersects the horizontally extending longitudinal axis 138. This alternative aerodynamically shaped outer surface profile also reduces weight, vibration and turbulence during operation.

FIG. 5C shows another alternative central hub member 122-2 that can be used in lieu of the central hub member 122 of FIGS. 2-4. In this case, the hub member 122-2 has an outer extending surface 140 that takes a substantially airfoil-shaped configuration with a flat lower surface and curvilinearly extending upper surface that, as in FIG. 5B, taper along a trailing edge. In this case, the hub-member 122 is asymmetric both about the vertically extending rotational axis 130 and the horizontally extending longitudinal axis 138. This alternative aerodynamically shaped outer surface profile also reduces weight, vibration and turbulence during operation.

FIG. 6 shows a coupling arrangement that can be used to adjoin the central hub member 122 to the arm member 124 in some embodiments. It will be understood that a similar arrangement can be used to adjoin the central hub member 122 to the other arm 126. Various features previously discussed are shown in FIG. 6, including interior channels 132, 134 which are axially aligned along the longitudinal axis 138.

In FIG. 6, each end of the central hub member 122 includes a threaded projection 142 which threadingly engages a corresponding threaded aperture portion 144 of the arm member 124, so that a male-to-female connection is made. This is merely illustrative and is not limiting, in that other coupling arrangements can be made including one where each of the arms 124, 126 have projections that threadingly engage a corresponding aperture in the central hub member 122.

A pair of corresponding limit surfaces are depicted at 146 and 148, respectively. These surfaces are supplied on each of the hub member 122 and the arm member 124 respectively, and serve as shoulder surfaces that contactingly interconnect upon the rotational threading and tightening of the arm 124 onto the projection 142 of the hub member 122. The respective limit surfaces 146, 148 are configured to prevent further rotation of the arm 124 relative to the hub 122 beyond a fully tightened position. This ensures that the associated nozzle 128 affixed to a distal end of the arm 124 (see FIG. 4) is finally positioned at the desired offset angle to induce rotation of the spray bar.

At this point it will be noted that any suitable angular orientations can be used for the nozzles 128, such as but not limited to from about 5 degrees to upwards of 30 degrees or more with respect to vertical; however, in some embodiments the respective nozzles will be oriented at angles of about 15 degrees with respect to vertical.

A fluid tight seal is established between the corresponding threads of the projection 142 and aperture 144. As desired, a separate sealing member, such as a layer of sealing tape, compound, an elastomeric gasket, etc. can be used to further ensure a fluid-tight seal is established at the junction of the hub member 122 and the arm member 124.

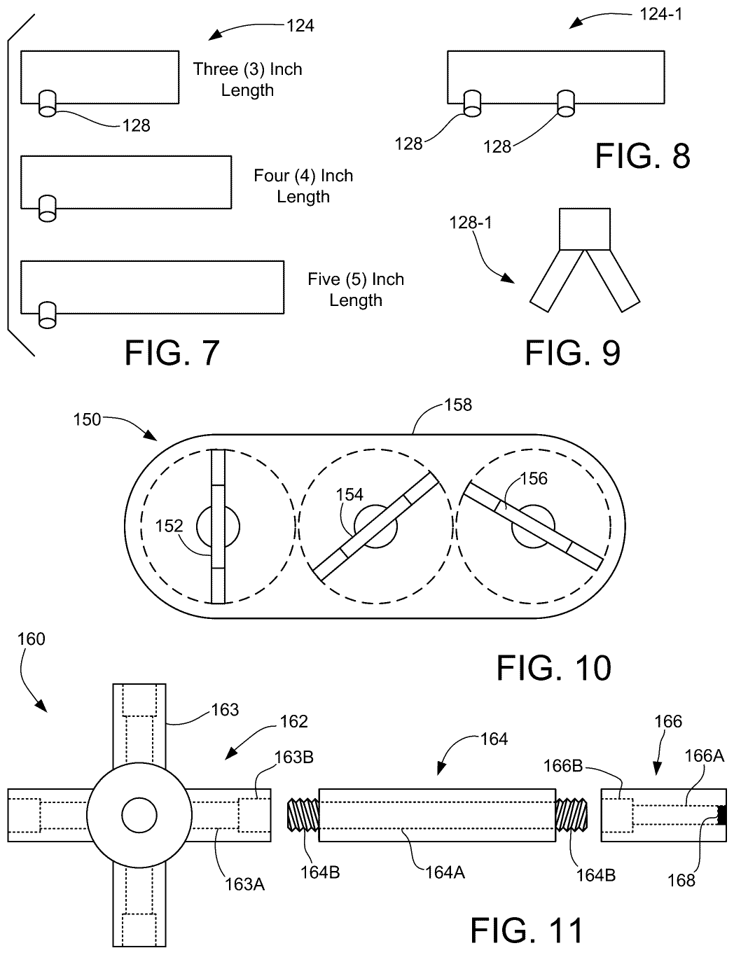

FIGS. 7-10 show additional embodiments that can be incorporated into the system as desired, depending on the requirements of a given application. FIG. 7 shows that a variety of different length/sized arm members 124 can be utilized. As noted above, a standard length central hub member 122 can be provided with a selected length, such as 10 inches, and then various length arms (such as 3 inches, 4 inches, 5 inches, etc.) can be attached to the respective ends of the spray bar to provide different overall lengths (in this example, bars of 16, 18 and 20 inches in length, etc.). Other various alternatives can be used so that the above values are merely illustrative and are not limiting.

FIG. 8 shows another arm member 124-1 with multiple spaced apart nozzles 128. The nozzles can be the same or different, be arranged at the same or different angles, and so on.

FIG. 9 provides an alternative nozzle assembly 128-1 that incorporates multiple nozzles (in this case, two) in a substantially Y-shaped configuration. In this way, a single orifice (e.g., 128A in FIGS. 3-4) can be used to drive multiple nozzles. Any number of nozzle configurations are contemplated and can be used as required.

FIG. 10 provides another representation of a flat surface cleaning machine 150 in accordance with further embodiments. The machine 150 is similar to the machine 102 depicted in FIG. 1, except that an elongated basedeck housing 158 is supplied to allow the concurrent rotational operation of multiple spray bar assemblies 152, 154, 156. While three spray bars are shown, any multiple number of bars can be provided in any suitable pattern, each receiving a supply of pressurized water (or other liquid) via respective swivel assemblies and other elements.

FIG. 11 shows an exploded schematic representation of yet another spray bar assembly 160 in accordance with further embodiments. Unlike the two-arm spray bars discussed above, the spray bar 160 in FIG. 11 is characterized as a four-way spray bar with a central hub member 162 with four arms 163 having interior channels 163A and threaded apertures 163B.

Four corresponding elongated hub members 164 are provided, each attachable to a separate one of the arms 163. Each hub member 164 may be aerodynamically shaped as described above in FIGS. 5A-5C and further has an interior channel 164A and opposing threaded projections 164B. Four corresponding arm members 166 are additionally supplied, each attaching to the distal end of each of the elongated hub members 164.

As before, the arm members 166 each include an interior channel 166A and a threaded aperture 166B. Limit shoulder surfaces can be provided to ensure precise engagement of the arms at the appropriate angles, including shoulder surfaces at each end of the hub member 164. In some embodiments, the various arm members 124, 166, etc. can have the interior channels 134, 166A pass wholly through the length of the channels, and then a plug or other sealing member 168 can be inserted at one end to divert the pressurized water to the associated nozzle outlet. This configuration can be useful in enhancing manufacturability of the devices.

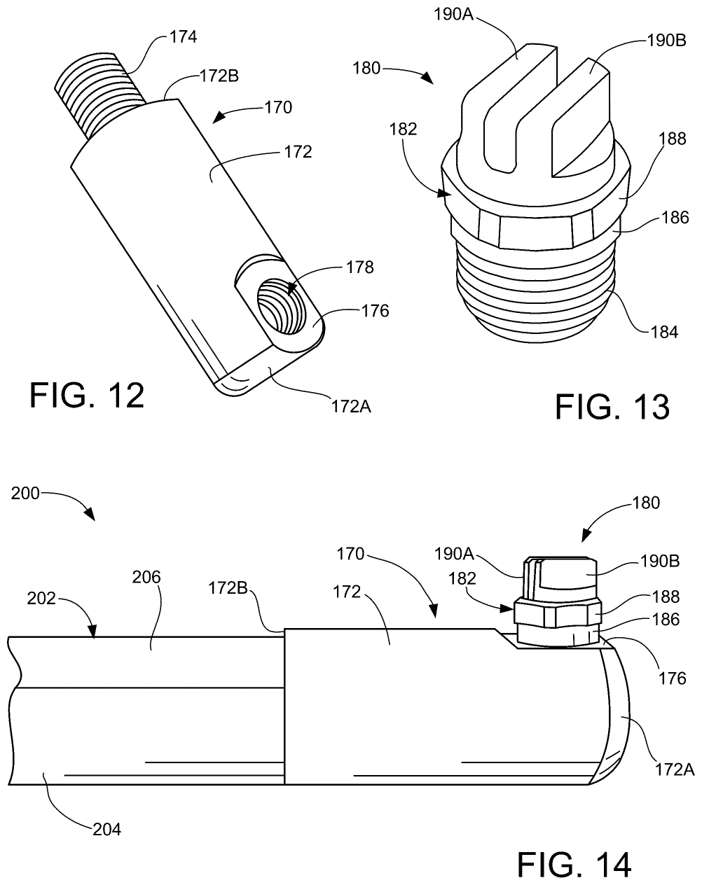

FIGS. 12-16 illustrate aspects of another spray bar assembly in accordance with further embodiments. Beginning with FIG. 12, shown therein is an isometric depiction of an arm member (arm) 170 similar to the arms described above. The arm 170 is generally cylindrically shaped with a cylindrical outer wall surface 172. The surface 172 terminates with a curvilinearly extending tapered end surface 172A at a first end, and a flat shoulder surface 172B (best viewed in FIG. 14) at an opposing second end.

A threaded coupling 174 extends from the second end of the arm. The threads of the male-configured coupling 174 engage a female-configured threaded recess (bore) within a corresponding hub (see element 202, FIG. 14) in a manner similar to those embodiments described previously. It will be noted that both male and female-configured ends (e.g., both threaded couplings and threaded bores) are collectively referred to herein as “threaded ends.”

A flat support surface 176 is machined or otherwise formed in the outer surface 172 of the arm 170 (see FIG. 12). A threaded bore 178 extends through the flat support surface and into the interior of the arm 170. The bore 178 is in open fluidic communication with a central interior channel (not separately shown) of the type discussed above in FIGS. 3, 6 and 11 to flow through the body of the arm and out a nozzle 180, as shown in FIG. 13.

The nozzle 180 is similar to those described previously in FIGS. 2-3 and 7-9 and includes a central body portion 182 from which extends a threaded coupling 184. The coupling 184 is sized to threadingly and sealingly engage the bore 178 in FIG. 12. An annular base portion 186 serves as a support surface to contactingly engage the flat support surface 176 (see FIG. 14). A hexagonal nut portion 188 surrounds the body of the nozzle 180 to allow engagement with a wrench, socket or other tool to threadingly install the nozzle 180 onto the arm 170.

A pair of spaced-apart ear portions 190A, 19B project upwardly from the nut portion 188 to direct a flow of the pressurized water along a desired path. While not expressly shown in FIG. 13, an interior channel extends between the ear portions and down through the threaded coupling 184 to communicate with the interior channel of the arm 170.

FIG. 14 shows an end isometric view of an assembled spray bar assembly 200 which includes the arm 170 from FIG. 12 and the nozzle 180 from FIG. 13. A distal end of a hub member 202 includes a cylindrical outer surface portion 204 and a flat surface portion 206. In this way, the hub member 202 takes a generally D-shaped cross-sectional shape similar to those shown above in FIGS. 4 and 5A.

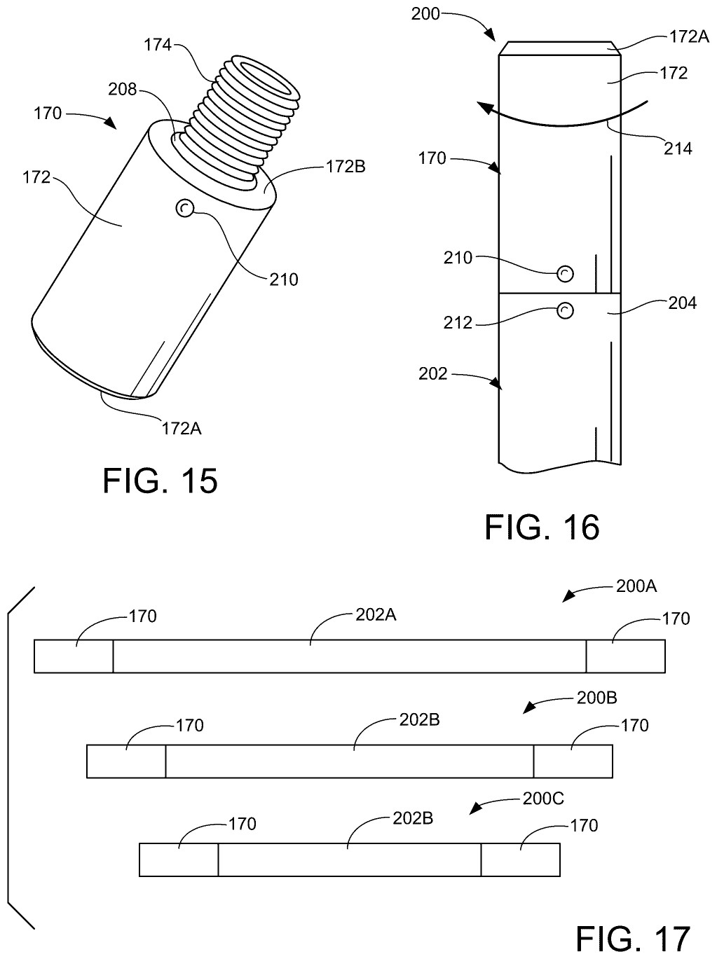

FIG. 15 provides another isometric view to better illustrate the opposing second end of the arm 170 from FIG. 12. The previously mentioned shoulder surface 172B can now be seen to comprise a flat annular surface which surrounds the base of the threaded coupling 174. The shoulder surface 172B operates as described above to limit the threading engagement of the arm 170 with the hub member 202 to a desired depth and rotational orientation for the nozzle 180. A corresponding flat surface (not separately shown in FIGS. 12-16) is provided in the end of the hub member to contactingly engage the shoulder surface 172B when the arm is installed.

A sealing compound 208 can be applied to the threads of the coupling 174, such as at the base of the coupling, to further ensure a fluidic seal between the arm and the hub. A human visible indicia mark 210, such as in the form of an inwardly extending recess, lines up with a corresponding indicia mark 212 on the hub member 202. In this way, as the user rotates the arm 170 relative to the hub 202 (along rotational direction 214), the respective marks 210, 212 can aid the user in ensuring that the arm has been fully installed and seated against the hub without overtorquing the member (which can cause structural damage) or undertorquing the member (which can cause misalignments and leaks).

Any number of different types of marks can be supplied (e.g., printed or etched lines, dimples, etc.) to aid the user in installing the arm onto the hub. Suitable tools including channel lock wrenches, fixturing, etc. can be used to respectively grasp the arm and hub members 170, 202. While not separately shown, hexagonal tooling surfaces (e.g., nut surfaces similar to the nut portion 188 in FIG. 13) can be formed on the outer surfaces of the arm and/or hub members to facilitate threading installation of the arm onto the hub by the user through the use of wrenches or other grasping tools.

FIG. 17 shows a family of two-way spray arm assemblies 200A, 200B and 200C that are generally similar to the spray arm assembly 200 variously illustrated in FIGS. 12-16. In this case, standard-sized arms 170 with an overall body length of about 3 inches are used on different length hub members 202A, 202B and 202C. In this way, all of the arms 170 can be nominally identical, can have different nozzles (e.g., 180) installed based on the requirements of a given application, and then installed onto different length hubs 202A-202C to provide overall desired lengths of the spray bars (e.g., from 17-24 inches or some other values as required).

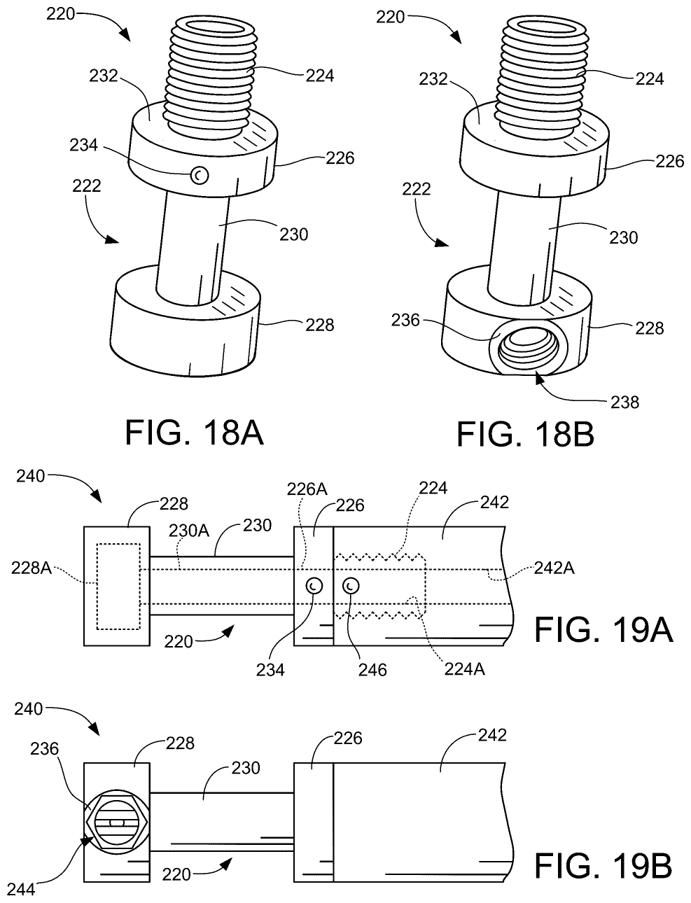

FIGS. 18A and 18B show respective front and rear facing views of another arm (end) member 220 in accordance with further embodiments. The arm member 220 is generally similar to the arm member 170 discussed above, and further includes aerodynamic shaping to reduce weight, vibration and turbulence during operation. The arm member 220 includes a central body portion 222 and a threaded coupling 224 which extends from the central body portion 222 in a manner similar to the threaded coupling 174 to engage a corresponding hub member (not shown).

The central body portion 222 includes an inner housing 226, an outer housing 228 and an intermediate portion 230. In this context, “inner” and “outer” are taken with respect to the rotational axis about which the assembled spray bar rotates. The intermediate portion 230 can be cylindrically shaped as shown, or can take some other configuration. While not shown in the drawings for clarity of illustration, the various edges of the main body portion 222 can be chamfered, radiused or otherwise shaped to further facilitate weight reduction and reduced turbulence.

The larger radius end housings 226, 228 and the smaller radius intermediate portion 230 thus provide an aerodynamically shaped outer surface profile that is substantially H-shaped in cross-sectional shape. It will be noted that the axis along which the H-shaped cross-section is orthogonal to the axis along which the D-shaped cross-section is taken for the hub members described above. Nevertheless, each of these and other disclosed aerodynamic profiles reduces weight, vibration and turbulence during operation.

As before, an upper shoulder surface 232 serves as a limit surface to sealingly engage the inner housing 226 against the corresponding hub member and to establish a desired rotational orientation (angle) of the arm member 220 relative to the hub by contactingly limiting further threading advancement of the arm member. User indicia 234 can be used to facilitate correct installation at this desired rotational angle.

FIG. 18B shows a flat support surface 236 and a threaded bore 238 of the outer housing. These elements serve to threadingly receive and support a nozzle as before.

FIGS. 19A and 19B show respective upper and lower views of a spray bar assembly 240 constructed using the arm member 220 of FIGS. 18A-18B. In this case, a selected arm member 220 threadingly engages a distal end of a hub member 242. Interior channels include an inlet channel 242A which axially extends within the hub member 242, a threaded coupling channel 224A which extends through the threaded coupling 224, an inner housing channel 226A which extends through the inner housing 226, an intermediate channel 230A which extends through the intermediate portion 230, and an outer housing channel 228A disposed within the outer housing 228A.

As before, these channels 224A, 226A, 228A, 230A, 242A collectively provide an internal flow path for the pressurized liquid to flow to and be emitted from a nozzle 244 (FIG. 19B). Indicia mark 246 on the hub member 242 nominally aligns with the indicia mark 234 when the arm 220 is properly installed.

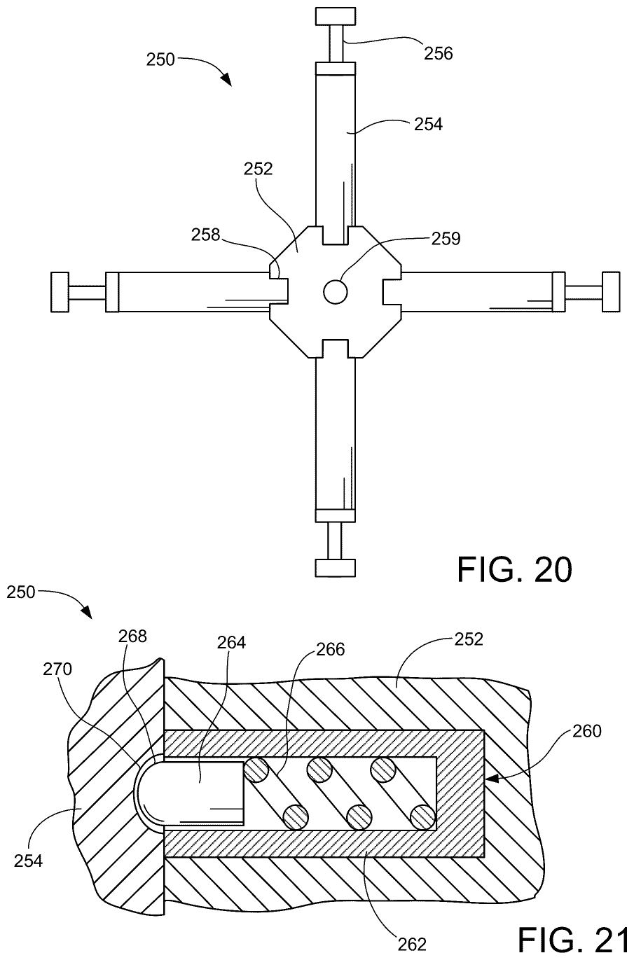

FIG. 20 shows a top-plan view of another four-way spray bar assembly 250 in accordance with further embodiments. The spray bar assembly 250 includes an octagonally shaped central hub member 252 from which four spaced-apart elongated hub members 254 extend. Attached to the distal ends of the elongated hub members 254 are shaped arm members 256. The hub and arm members 254, 256 can generally correspond to the hub and arm members 220, 242 in FIGS. 19A-19B or can take some other desired configurations. In one embodiment, the elongated hub members 254 are substantially cylindrical so that the aerodynamic shaping of the spray bar assembly 256 is limited to the narrowed contours of the arm members 256. In another embodiment, the hub members 254 are D-shaped or have some other non-cylindrical aerodynamic shaping so that both the arms and hub members are aerodynamically shaped.

As with the four-way spray bar embodiment of FIG. 11, the embodiment of FIG. 20 uses threaded couplings (not separately shown) to respectively attach the elongated hub members 254 to the central hub member 252 and the arm members 256 to the elongated hub members 256, Cutouts 258 are provided in the central hub 252 as shown to provide mechanical clearance for the upper radiused outer surfaces of the elongated hub members 254. A central inlet port 259 couples to a swivel (see FIG. 2) to receive the flow of pressurized fluid for distribution via the arms 256.

FIG. 21 is a cross-sectional view of internal aspects of the spray bar assembly 250 of FIG. 20 in further embodiments. Separate locking assemblies 260 can be embedded in the body of the central hub 252 to engage and lock each of the elongated hub members 254 in the desired rotational orientation. It will be appreciated that such locking mechanisms can take any number of suitable configurations so the example shown in FIG. 21 is merely illustrative and is not limiting.

The locking assembly 260 includes a cup shaped housing 262 which internally supports a plunger element (locking pin or ball) 264 which is spring biased via a biasing element 266 (in this case, a coiled spring). A radiused top surface 268 of the plunger element 264 is inserted into, and comes into contactingly engagement with, a detent recess 270 that extends into the hub member 254. In this way, the locking assembly 260 serves to allow threading engagement of the hub member 254 into the central hub 252 until the plunger element 264 extends into recess 272, after which the elongated hub member 254 is rotationally locked with respect to the central hub 252. While not shown in FIG. 21 for clarity, extension limiting features, such as a shoulder retention surface, can be provided to limit the maximum extent to which the plunger element 264 can extend from the housing 262.

While the elongated hub members 254 can be permanently affixed to the central hub 252, it is contemplated in at least some embodiments that the elongated hub members may be configured to be removably replaced to facilitate manufacturability and serviceablilty of the spray bar assembly. In such case, the locking assemblies such as 260 can be further configured to allow manual or automatic disengagement during subsequent repair operations to allow a given hub member 254 to be removed from the main body 252. As desired, locking assemblies such as 260 can be used elsewhere within a given spray bar configuration, including to lock the rotational positions of the arm members to the hub members (e.g., elements 254, 256 in FIG. 20, etc.).

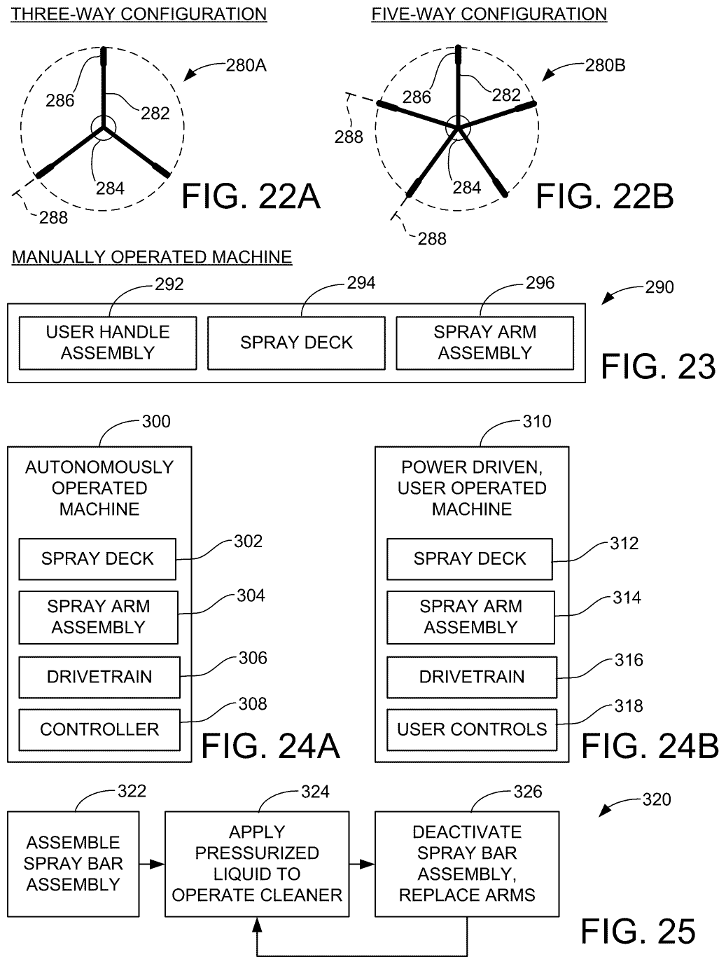

While two-way and four-way spray bar configurations have been discussed to provide respective T-shaped patterns and X-shaped patterns, substantially any number of hub and arm members can be provided so long as the overall configuration remains nominally balanced during rotational operation. A spray bar assembly 280A having a three-way (Y-shaped pattern) configuration is shown in FIG. 22A, and a spray bar assembly 280B having a five-way (star-shaped pattern) configuration is shown in FIG. 22B. It will be appreciated that six or more equally spaced-apart arms can also be used to provide additional star-shaped patterns as desired.

Each of the assemblies 280A, 280B have a series of radially projecting hubs 282 with a central spindle 284 and distal arms 286. Generally, a larger number of arm/nozzle combinations will facilitate a greater flow volume, albeit at a potential reduction in pressure, of the applied fluid. It will be noted that the pressurized fluid flows along one or more longitudinally extending axes of the various hub members, such as denoted by broken lines 288.

FIG. 23 shows a functional block diagram of another flat surface cleaning machine 290 similar to the machines 100, 100A described above in FIGS. 1-2. In this case, the machine 290 is a manually operated machine in which the user physically locates and moves the machine across the floor to be cleaned. As such, the machine 290 includes a user handle assembly 292 (similar to the assembly 102 in FIG. 1), an enclosed spray deck 294 (similar to the decks 108 in FIGS. 1-2), and a rotatable spray arm assembly 296 (similar to the various embodiments described above). Other elements can be incorporated into the machine as required.

In alternative embodiments, the various embodiments described herein can be readily incorporated into an autonomously operated machine 300, as represented in FIG. 24A. The machine 300, or autonomous vehicle (e.g., robot) can be programmed to cover a floor area using a predetermined path, or can adaptively discover and map out a coverage path using sensors and other elements as known in the art.

The autonomous vehicle 300 thus includes various elements including a spray deck 302, a spray arm assembly 304, a drivetrain 306 and a controller 308. The drivetrain may be an electric motor, a set of batteries, an ICE, or some other form of locomotion/power for the vehicle. The controller 308 may include one or more processors or microcontrollers to carry out the desired functions. While not shown in FIG. 24A, conduits can be extended to the vehicle from a source (see e.g., conduit 105 in FIG. 1), or on-board reservoir tanks, compressors, etc. can be used to supply the pressurized fluid.

FIG. 24B shows another machine in which various embodiments can be embodied, in this case a power driven, user operated machine 310. This may be similar to a Zamboni-type device that is user operated and driven to cover a desired floor surface. As such, the machine 310 includes a spray deck 312, a spray arm assembly 314, a drivetrain 316 and suitable user controls 318 (including a deck or chair for the user as desired). A walk-behind powered unit configuration is also envisioned and can be readily constructed in view of the present disclosure.

FIG. 25 is a simplified sequence diagram 320 for an operational sequence using the spray arm assemblies embodied herein. An initial spray bar assembly is assembled at block 322. This can be carried out at the factory so that the delivered machine (e.g., 100, 290, 300, 310) is pre-assembled and ready for use, or can be user assembled with desired elements (e.g., arms, nozzles, etc.).

Once assembled, the machine is thereafter activated and operated to clean a floor surface, block 324. As discussed previously and as known in the art, a supply of pressurized fluid is supplied to the unit, passed through the spray arm assembly to the ends thereof, and out the nozzles to provide rotating pressurized fluid washing of the underlying surface. The angled orientations of the nozzles impart rotational movement of the arms at a desired rotational rate (including several hundred rpms or more) and the spray arm is advanced across the floor surface using manual or automated means.

At some point it may be desirable to repair, upgrade or otherwise reconfigure the spray bar assembly, as shown by block 326. In such case, the machine is disconnected and the spray bar assembly is subjected to appropriate operations including the removal and replacement of the respective arms, hub(s) and/or nozzles. Once these operations are completed, the machine is returned to service as shown.

A variety of materials and constructions can be used to form the various members described herein. In some embodiments, the central hub members are formed of a lightweight durable material such as aluminum, and the arm members are formed of a more dense and durable material such as stainless steel. Other material configurations can be used. The parts can be machined, injection molded, printed, etc.

It will now be appreciated that the various embodiments of the present invention provide a number of advantages and benefits over the existing art. The various configurations can provide enhanced durability, reduced weight, improved airflow characteristics, and higher fluidic flow rates as compared to existing designs. The modular nature of the embodiments allows ease of assembly, use, repair and reconfiguration of the system as required.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising a spray bar assembly for use in a flat surface cleaning machine adapted for coupling engagement with a swivel to facilitate rotation thereof, the spray bar assembly comprising:
a central hub member comprising a main body having an inlet coupling to receive a flow of pressurized liquid aligned with a central rotational axis, a hub internal channel within the main body configured to flow the liquid along at least one longitudinal axis of the body from the inlet coupling to opposing first and second hub outlet couplings, the hub internal channel having a first internal diameter, the central hub member further comprising opposing first and second threaded ends at the respective first and second hub outlet couplings; and
first and second arms with corresponding threaded ends to mate with the first and second threaded ends of the first and second hub outlet couplings, each of the first and second arms having an arm internal channel in fluidic communication with the hub internal channel of the main body of the central hub member and at least one threaded aperture to receive a nozzle, the arm internal channel having a second internal diameter;
wherein each of the central hub member and first and second arms further having associated limit shoulder surfaces that, through contacting engagement, set the rotational position of each of the first and second arms at desired angles with respect to the longitudinal axis while establishing fluidic seals between the central hub member and the first and second arms; and
wherein at least a selected one of the first and second arms or the main body of the central hub member has an aerodynamically shaped outer surface profile to facilitate efficient rotation of the central hub member.

2. The apparatus of claim 1, wherein the second internal diameter of the arm internal channel is smaller than the first internal diameter of the hub internal channel.

3. The apparatus of claim 1, wherein the first and second hub outlet couplings are axially aligned along a common longitudinal axis to provide a T-shaped spray bar assembly configuration.

4. The apparatus of claim 1, wherein the first and second hub outlet couplings are offset with respect to a common longitudinal axis to provide a selected one of an X-shaped spray bar configuration, a Y-shaped spray bar configuration or a star-shaped spray bar configuration.

5. The apparatus of claim 1, wherein the aerodynamically shaped outer surface profile of the main body of the central hub member comprises a D-shaped cross-section.

6. The apparatus of claim 5, wherein the D-shaped cross-section is formed by a cylindrical outer wall portion which adjoins a flat outer wall portion.

7. The apparatus of claim 1, wherein each of the first and second arms has opposing first and second ends, the first end characterized as a threaded end to threadingly engage the corresponding first and second hub outlet couplings, the second end comprising a threaded bore to threadingly receive a nozzle installed therein at a selected rotational angle established by the associated limit shoulder surface.

8. The apparatus of claim 7, wherein the selected rotational angle is from nominally 5 degrees to nominally 30 degrees in a direction about the longitudinal axis.

9. The apparatus of claim 7, wherein each of the first and second arms has a cylindrical outer surface portion into which extends a flat support portion surrounding the threaded bore at the second end thereof, the nozzle contactingly supported on the flat support portion.

10. The apparatus of claim 1, wherein the central hub member is formed of aluminum and the first and second arms are each formed of stainless steel.

11. The apparatus of claim 1, wherein the spray bar assembly is arranged for rotation within an inverted, cup-shaped deck of the flat surface cleaning machine so that a flow of pressurized water is directed from the spray bar assembly, against an underlying flat surface that supports the flat surface cleaning machine.

12. A flat surface cleaning machine, comprising:
an inverted, cup-shaped deck which provides an interior annular space;
a swivel mounted to a central location of the cup-shaped deck and coupled to a source of pressurized liquid; and
a spray bar assembly disposed within the cup-shaped deck and coupled to the swivel to receive and impart a flow of the pressurized liquid from the source to an underlying flat surface, the spray bar assembly comprising a hub member, an arm member, and a nozzle, the hub member having an elongated body with an aerodynamically shaped outer wall surface and a hub internal channel extending along a longitudinal axis from a hub proximal end to a hub distal end, the arm member having an arm internal channel extending along the longitudinal axis from an arm proximal end to an arm distal end, the arm proximal end configured to threadingly engage the hub distal end during rotation of the arm member relative to the hub member to bring a first limit shoulder surface of the hub member into contacting engagement with a second limit shoulder surface of the arm member to set a final rotational angle of the arm member relative to the hub member, the nozzle contactingly supported by the arm distal end and projecting therefrom at the rotational angle established by the first and second limit shoulder surfaces.

13. The machine of claim 12, further comprising a user handle assembly configured to facilitate physical advancement of the machine across the underlying surface by a user.

14. The machine of claim 12, characterized as a selected one of an autonomously operated vehicle or a power driven, user operated vehicle.

15. The machine of claim 12, wherein the aerodynamically shaped hub member has a D-shaped cross-section.

16. The machine of claim 12, wherein the aerodynamically shaped hub member has a selected one of a tear-drop shaped cross-section or an airfoil-shaped cross-section.

17. The machine of claim 12, wherein the arm member further has an aerodynamically shaped outer surface profile with an H-shaped cross-section.

18. The machine of claim 12, wherein the hub member is a first hub member and the arm member is a first arm member, and wherein the spray bar assembly comprises at least one additional hub member and arm member to provide a selected one of a T-shaped pattern, an X-shaped pattern, a Y-shaped pattern or a star-shaped pattern.

19. The machine of claim 12, further comprising a first alignment mark arranged on the proximal end of the arm member and a second alignment mark arranged on the distal end of the hub member, the first and second alignment marks providing a visual indication to the user during rotational installation of the arm member onto the hub member to indicate alignment thereof at the final rotational angle.

20. The machine of claim 12, wherein the arm member comprises a cylindrically shaped main body portion, wherein a male-configured threaded coupling extends from the arm proximal end for threading inserting into a corresponding female-configured threaded bore in the distal end of the hub member, and wherein a recessed flat surface portion is formed in the arm distal end to cntactingly engage a support portion of the nozzle during installation of the nozzle into a threaded bore of the arm distal end.
